(19) United States
(12) Patent Application Publication
(10) Pub. No.: US 2010/0326581 A1
(43) Pub. Date: Dec. 30, 2010

(54) METHOD AND SYSTEM FOR APPLYING LABELS TO A SUBSTRATE

(75) Inventor: Morton F. Roseman, Thornhill (CA)

Correspondence Address: BAKER & DANIELS LLP;111 E. WAYNE STREET, SUITE 800, FORT WAYNE, IN, 46802, US

(73) Assignee: Custom Security Industries Inc., Thornhill, ON (CA)

(21) Appl. No.: 12/823,761

(22) Filed: Jun. 25, 2010

(30) Foreign Application Priority Data
Jun. 26, 2009 (CA) 2670332

(51) Int. Cl. B32B 37/16; B32B 33/00

(52) U.S. Cl. 156/60; 156/538; 428/41.8

(57) ABSTRACT

A method for applying labels to a substrate comprises providing a release liner having a repeating sequence of pluralities of pressure-sensitive labels disposed thereon, each of the pluralities comprising at least two labels and applying at least one plurality of labels to a substrate using a label applicator.

### FIELD OF THE INVENTION

The present invention relates generally to labeling and in particular, to a system for applying labels to a substrate and a method for same.

### BACKGROUND OF THE INVENTION

Pressure-sensitive labels, commonly referred to as “peel and stick” or “self adhesive” labels, are manufactured in a range of sizes and shapes for application to substrates such as commercial products. These labels can be formed of any of a variety of materials, such as plastic film, paper, synthetic paper, or metallized film, and have one side coated with adhesive that enables the labels to be applied to the products. The labels are fabricated at a low cost, and can be applied to substrates in a reliable manner and at high speed using automated applicators.

Pressure-sensitive labels are used for a number of different purposes. Decorative labels can be used for aesthetic purposes. Alternatively, pressure-sensitive labels can be printed with optically scannable information such as a universal product code (UPC) or a “barcode” for enabling a labeled substrate such as a commercial product to be identified by an optical scanner, for example. Functional labels comprise a functional device or a sensor, and can be applied to products for a variety of purposes including remote identification and electronic article surveillance (EAS). For example, a label including a radio frequency identification (“RFID”) device applied to a product enables the product to be identified and/or tracked remotely by a suitable radio frequency-based detector. EAS devices, commonly known as “anti-theft” or “anti-shoplifting” devices, enable an EAS labeled product to be detected by anti-theft detectors. Such EAS devices include electromagnetic (EM), acousto-magnetic (AM), radio-frequency (RF), and microwave (MW) devices. Labels incorporating anti-theft devices are currently used for application to library books, for example, and to a wide range of commercial products.

Pressure-sensitive labels are typically supplied by label manufacturers in rolls, with the labels being disposed in a periodic order on the surface of a release liner. The labels can then be applied to substrates by hand or, in high-volume manufacturing environments, by an applicator device that is loaded with a roll of the labels.

In some situations, it is required to apply multiple labels to a substrate. This can be accomplished by several different approaches. In one approach, multiple applicator devices, each loaded with a roll of labels, are used to each apply a different label to the substrate in a single pass. In another approach, a single applicator device loaded with a roll of one kind of label is used to apply the label to the substrate in a first pass. The applicator device is then loaded with a roll of another kind of label, and is used to apply the label to the substrate in a second pass.

In still another approach, multiple functional devices, which could otherwise each be incorporated into individual labels and applied separately to a product, are integrated into a single label using packaging material. For example, U.S. Pat. No. 7,345,583, to Reid et al. discloses a dual security label comprising a cover stock body comprising a first side and a second side, with an adhesive on the second side of the cover stock body. A first antitheft device may be adhered to the adhesive and a second antitheft device may be adhered to the adhesive. The exposed adhesive may be used for adhering the dual security label to products being sold by retailers or may be used for adhering to an enclosing member.

As label applicators are generally expensive, it is desirable to reduce the number of label applicators used for applying multiple labels to a substrate. It is also desirable to reduce the number of passes of the substrate, so as to increase throughput and reduce the cost of the label application process. At the same time, it is desirable to avoid packaging of multiple devices into a single label, so as to avoid the use of packaging material and to thereby reduce the cost of the label application process.

It is therefore an object of the present invention to provide a novel method and system for applying labels to a substrate.

### SUMMARY OF THE INVENTION

Accordingly, in one aspect there is provided a method for applying labels to a substrate comprising providing a release liner having a repeating sequence of pluralities of pressure-sensitive labels disposed thereon, each of the pluralities comprising at least two labels; and applying at least one plurality of labels to a substrate using a label applicator.

In one embodiment, the applying comprises applying the at least one plurality of labels to substrates delivered to the label applicator in succession. The applying may further comprise applying only one plurality of labels to each substrate.

In one form, the at least two labels of each plurality are disposed on a surface of the release liner. In another form, a first label of each plurality is disposed on a surface of the release liner and at least one second label is disposed on a surface of the first label. The at least two labels of each plurality may be any of decorative labels, alphanumeric labels, barcode labels, and labels comprising a functional device. In the case of labels comprising a functional device, the functional device may be any of an electromagnetic device, an acousto-magnetic device, a radio frequency device, a microwave device, and a radio frequency identification device. Alternatively, at least one of the at least two labels of each plurality may be an anti-theft label.

According to another aspect, there is provided a label carrier comprising a release liner having a repeating sequence of pluralities of pressure-sensitive labels disposed thereon, each plurality of labels comprising at least two differing labels.

According to yet another aspect there is provided a label application system comprising a label applicator loaded with a label carrier as described above; and a conveying mechanism to deliver substrates in succession to said label applicator, said label applicator applying at least one plurality of labels to each substrate.

### BRIEF DESCRIPTION OF THE DRAWINGS

Embodiments will now be described more fully with reference to the accompanying drawings in which:

FIG. 1 is a schematic side elevational view of a label application system;

FIGS. 2a and 2b are top plan and side elevational views, respectively, of a label carrier for use with the label application system of FIG. 1;

FIG. 3 is a schematic side elevational view of a preparation system for the label carrier of FIG. 2;

FIGS. 4a and 4b are schematic top plan and side elevational views, respectively, of another embodiment of a label carrier for use with the label application system of FIG. 1;

FIGS. 5a and 5b are schematic top plan and side elevational views, respectively, of yet another embodiment of a label carrier for use with the label application system of FIG. 1;

FIGS. 6a and 6b are top plan and side elevational views, respectively, of still yet another embodiment of a label carrier for use with the label application system of FIG. 1; and

FIG. 7 is a schematic side elevational view of a preparation system for the label carrier of FIGS. 6a and 6b.

### DETAILED DESCRIPTION OF THE EMBODIMENTS

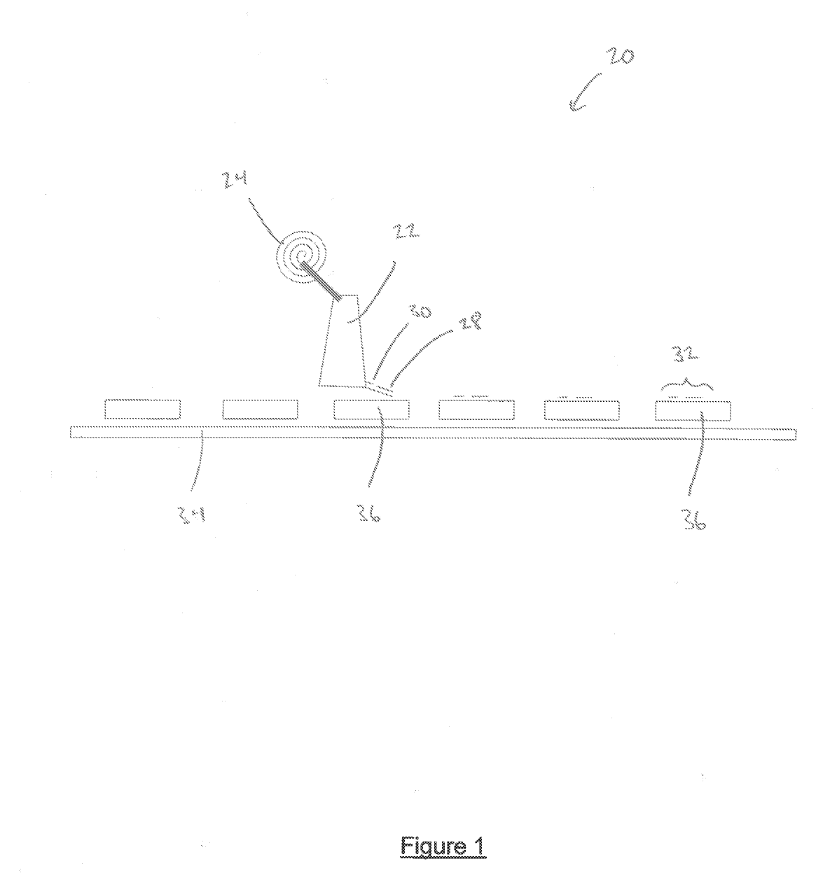

The following is directed to a system and method for applying a plurality of pressure-sensitive labels to a substrate, such as an item of merchandise or a commercial product. The system utilizes a single label applicator that is loaded with a label carrier comprising a release liner onto which pluralities of labels are disposed in a repeating sequence. This arrangement of the labels on the release liner allows the label applicator to apply each of the labels in the plurality to the substrate simultaneously, and in what is essentially a single pass process. The method may be used to apply pressure-sensitive labels of any type to substrates in a high-speed/high-volume manner, and obviates the need for multiple label applicators to each apply one of the labels in the plurality to the substrate, or the need for multiple passes of the substrate when only a single label applicator is used. Various embodiments of the label application system and method will now be described with particular reference to FIGS. 1 to 7.

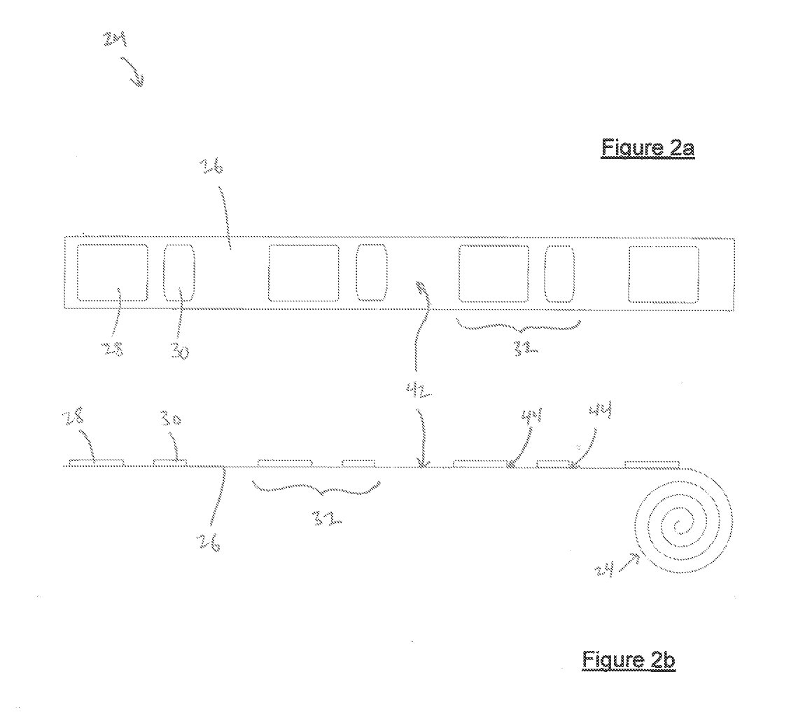

Turning now to FIGS. 1 to 3, a system for applying multiple labels to a substrate is shown, and is generally indicated by reference numeral 20. System 20 comprises a label applicator 22 that is loaded with a label carrier 24 comprising pressure-sensitive labels. In this embodiment, label carrier 24 comprises a release liner 26 having a surface onto which first type labels 28 and second type labels 30 are disposed in an alternating repeating sequence (see FIG. 2). System 20 also comprises a delivery mechanism 34 such as a conveyor belt or the like that brings substrates 36 into communication with the label applicator 22 in succession for the application of a plurality 32 of labels to each substrate 36 substantially simultaneously. In this embodiment, by “substantially simultaneously”, it is meant that both labels 28 and 30 are applied to each substrate 36 at the same time or at approximately the same time, and in what is essentially a single pass process. As is known in the art, label applicator 22 can be programmed to position labels 28 and 30 on each substrate 36 in any desired arrangement.

System 20 may be used to apply pressure-sensitive labels of any size, shape, material, and function to the substrates 36. In this embodiment, first type label 28 is a radio-frequency (“RF”) anti-theft label, and differs in shape from second type label 30, which is an acousto-magnetic (“AM”) anti-theft label. However, first type label 28 and second type label 30 need not differ in shape, in function, or in any other aspect.

The label carrier 24 is better illustrated in FIG. 2. Release liner 26 of label carrier 24 has a low-adhesion surface 42 onto which labels 28 and 30 are disposed. In this embodiment surface 42 is a silicone surface, but low-adhesion surface 42 can be any suitable low-adhesion surface known in the art. First type label 28 and second type label 30 each comprise an adhesive side 44 having an adhesive coating, and which is in contact with the low-adhesion surface 42 of release liner 26. As is known in the art, the silicone surface of low-adhesion surface 42 does not damage or remove the adhesive coating disposed on the labels 28 and 30, allowing labels 28 and 30 to be readily removed from release liner 26 by label applicator 22 and adhered to substrates 36 upon application.

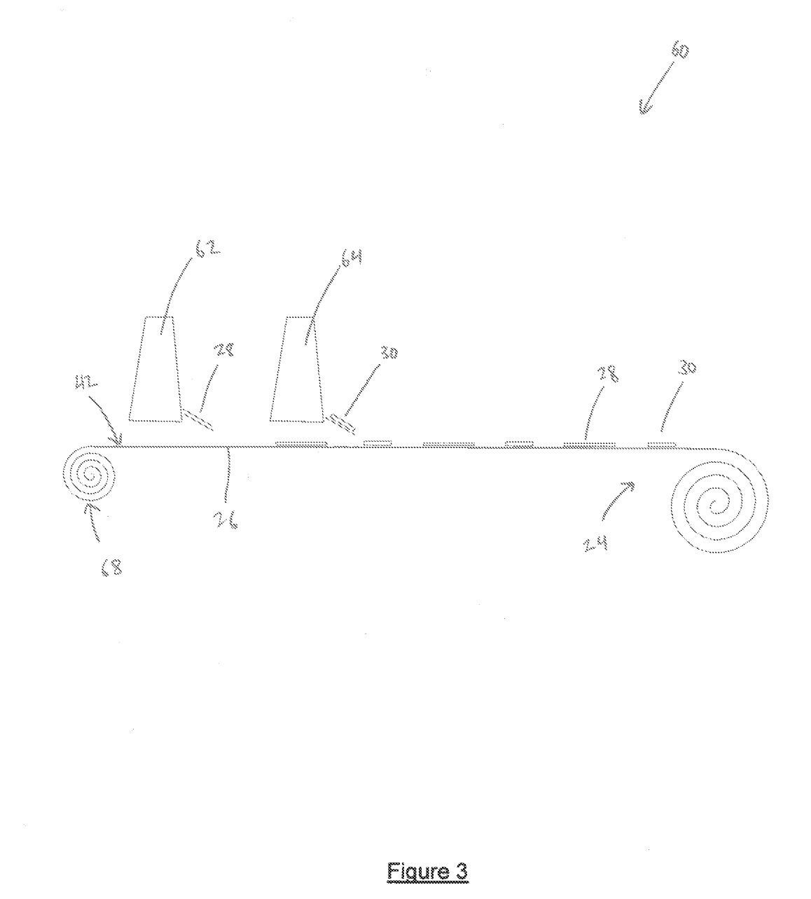

FIG. 3 shows a carrier preparation system that may be used to prepare the label carrier 24, and which is generally indicated by reference numeral 60. Carrier preparation system 60 comprises a first label applicator 62 and a second label applicator 64. First label applicator 62 is in communication with a supply (not shown) of first type labels 28, and second type label applicator 64 is in communication with a supply (not shown) of second labels 30. Carrier preparation system 60 also comprises a release liner supply 68, which is configured such that low-adhesion surface 42 of release liner 26 is brought into communication sequentially with first label applicator 62 and with second label applicator 64 for application of first type labels 28 and second type labels 30, respectively, to release liner 26. In this embodiment, first type label 28 and second type label 30 are arranged in single file longitudinally along release liner 26, and therefore such that the labels 28 and 30 within each plurality 32 are arranged in single file. However, as will be appreciated, first type label 28 and second type label 30 can be arranged in any pattern within each plurality 32. Label carrier 24, comprising labels 28 and 30 disposed on the release liner 26, is then spooled for use with system 20 for the application of the labels 28 and 30 to the substrates 36.

First and second applicators 62 and 64 can be programmed to position the labels 28 and 30 on release liner 26 as required, for example to provide a spacing of the labels 28 and 30 on release liner 26 such that applicator 22 of system 20 can easily apply one first type label 28 and one second type label 30 substantially simultaneously to the substrate 36. It will be appreciated that accuracy and repeatability in the placement of labels 28 and 30 onto release liner 26 is required for subsequent use by system 20. This can be complicated if carrier preparation system 60 is operated at a high speed. However, accuracy in positioning may be achieved by using any suitable process monitoring equipment known in the art. For example, photoelectric sensors (not shown) can be used in conjunction with label applicators 62 and 64 to monitor the positioning of labels 28 and 30 onto release liner 26, and velocity sensors (not shown) and/or tachometers (not shown) may be used with air-driven shafts (not shown) associated with carrier supply 68 and/or the spool of label carrier 24 to provide velocity data of the release liner 26 as it travels through carrier preparation system 60.

As will be appreciated, in this embodiment, system 20 applies a plurality 32 of labels from the carrier 24 onto the substrate 36 without requiring interconnection, packaging, or bundling together in any way of the labels. Additionally, release liner 26 remains integral as it passes through both system 20 and through carrier preparation system 60, and it is not required that release liner 26 be cut or have seams formed in relation to the labels 28 and 30 disposed thereon to otherwise facilitate the application of the labels to substrate 36. This removes need for any label packaging materials or release liner cutting equipment, which lowers the cost of the method relative to other methods used for the application of multiple labels to a single substrate.

The labels can be any pressure-sensitive label known in the art, and can be decorative labels, alphanumeric labels, barcode labels (e.g. those comprising a product bar code such as a universal product code), or labels comprising a “functional device”. The functional device can be any device or any sensor that can be integrated into a pressure-sensitive label such as, but not limited to, radio frequency identification (RFID) devices; electronic article surveillance (EAS) devices (commonly known as “anti-theft” or “anti-shoplifting” devices), such as electromagnetic (EM), acousto-magetic (AM), radio-frequency (RF), and microwave (MW) devices. Such labels include, but are not limited to, radio-frequency identification (RFID) labels, such as those manufactured by UPM Raflatac of Fletcher, N.C. and Checkpoint Systems, Inc. of Thorofare, N.J.; acousto-magnetic (AM) labels, such as those manufactured by Tyco International, Ltd. of Princeton, N.J.; and radio-frequency (RF) labels, such as those manufactured by ALL-TAG Security of Boca Raton, Fla., and by Checkpoint Systems, Ltd.

The label applicators can be any label applicators known in the art. A wide variety of existing label application equipment may be used with the systems described above, such as that manufactured by Accraply of Minneapolis, Minn. (e.g. Accraply model 350 or Accraply model 380), or that manufactured by Label-Aire of Fullerton, Calif.

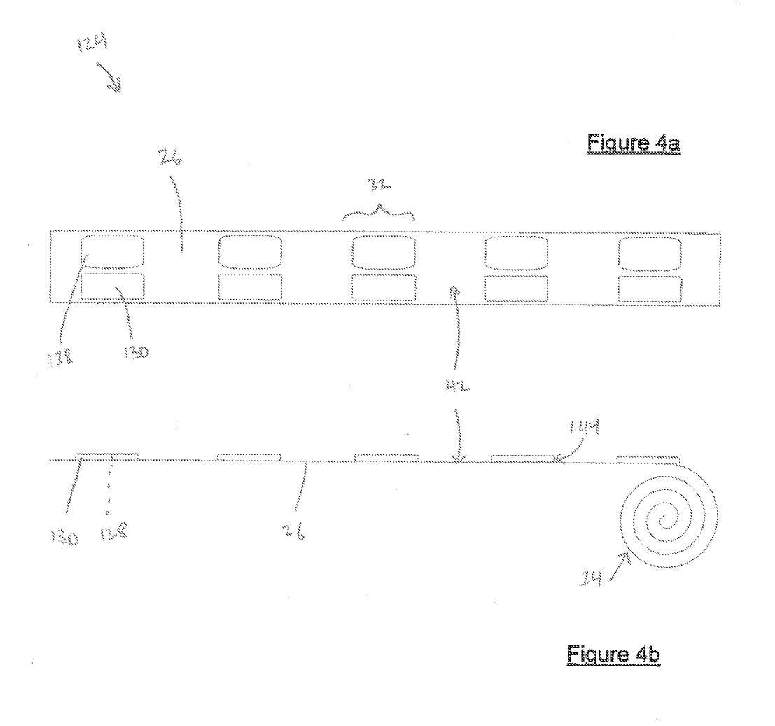

The labels within each plurality may be arranged in a variety of ways. FIGS. 4a and 4b show another embodiment of a label carrier, generally indicated using reference numeral 124, having an alternative arrangement of labels in which a first type label 128 and a second type label 130 are arranged “side-by-side”. It will however be appreciated that still other arrangements are possible.

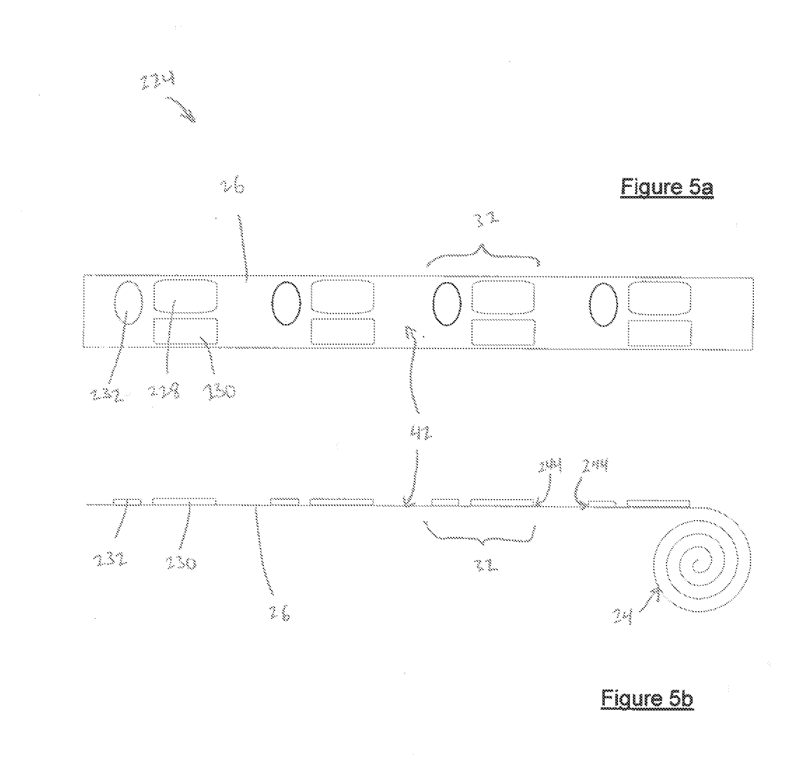

Although the above embodiments describe the plurality of labels as comprising two labels, the plurality is not limited to this number and may alternatively comprise any number of labels. For example, FIGS. 5a and 5b show another embodiment of a label carrier 224 having a repeating sequence of pressure-sensitive labels disposed thereon, wherein each plurality 232 of labels comprises three labels, namely first type label 228, second type label 230, and third type label 231, disposed on a release liner 26.

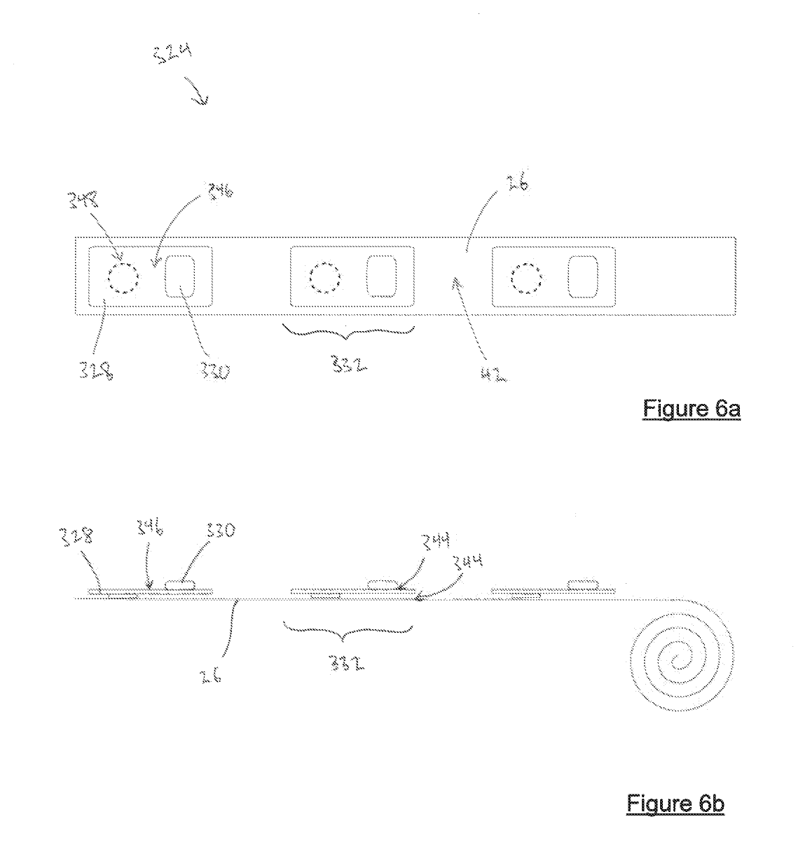

Still other arrangements of labels within each plurality are possible. For example, FIGS. 6a and 6b show yet another embodiment of a label carrier, generally indicated using reference numeral 324, comprising a release liner 26 on which a repeating sequence of pressure-sensitive labels is disposed. In the embodiment shown, each plurality 332 comprises a first type label 328 disposed on a surface of the release liner 26. First type label 328 has a label surface 346, onto which a second type label 330 is disposed. As will be appreciated, this arrangement of labels 328 and 330 allows the application of the plurality 332 of labels to a substrate (not shown) during use with a label application system, such as system 20 described above, to be simplified, as only first type label 328 is required to be delaminated from release liner 26 during application.

Similar to the embodiments described above, first type label 328 and second type label 330 each comprise an adhesive side 344 having an adhesive coating. The adhesive coating 344 of first type label 328 is in contact with a low-adhesion surface 42 of release liner 26. The adhesive coating 344 of second type label 330 is in contact with the label surface 346, which is sized to accommodate the second type label 330.

In the embodiment shown, first type label 328 is a radio-frequency electronic article surveillance label (RF EAS) label, and has an active region 348 that generally corresponds to an RF EAS device located within first type label 328. Surface 346 is located adjacent to active region 348, so that second type label 330 is suitably spaced from the active region 348 so as to not interfere with the functioning of the RF EAS device. Those of skill in the art will understand that the first type label 328 need not be limited to an RF EAS label, and may alternatively be any kind of label, and with or without a device having an associated active region.

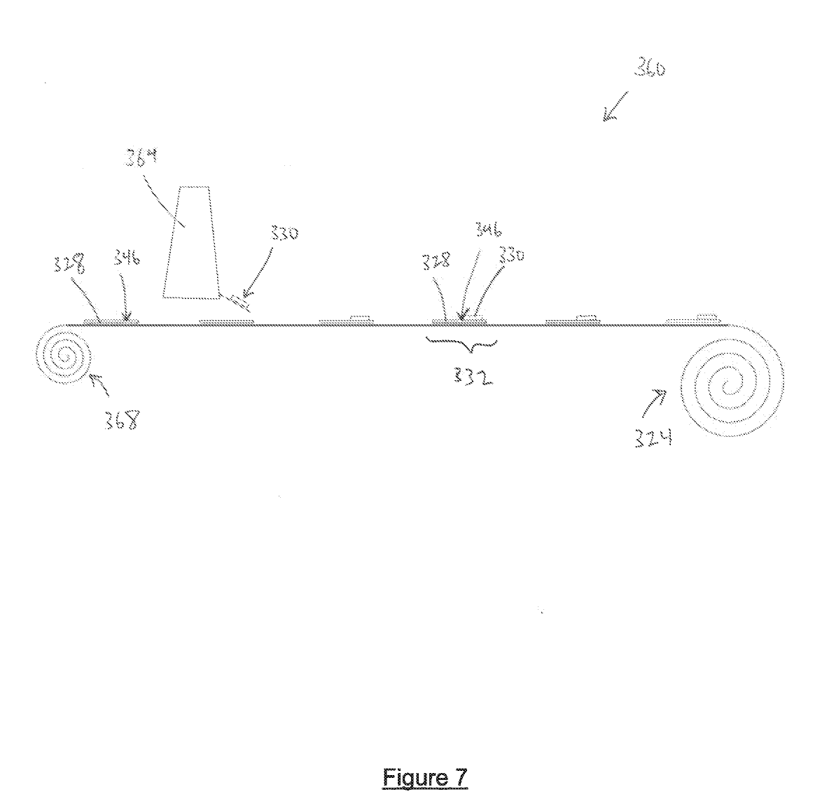

FIG. 7 shows a carrier preparation system that may be used to prepare the label carrier 324, and is generally indicated by reference numeral 360. Carrier preparation system 360 comprises a label applicator 364 that is in communication with a supply 368 of first type labels 328 disposed in a repeating sequence on release liner 26. The supply 368 is configured such that the first type labels 328 are brought into communication with the label applicator 364 for application of the second type labels 330 to the label surfaces 346. Label carrier 324, having both first type labels 328 and second type labels 330 disposed thereon, is then spooled for subsequent use with a label application system, such as label application system 20 described above, for the application of the labels 328 and 330 to substrates. As will be understood, the release liner 26 of label carrier 324 is the original release liner of first type labels 328, which allows the first type labels 328 to remain on the original release liner during the preparation of the label carrier 324, and thereby eliminates the need to remove the first type labels 328 from the release liner during the preparation of the label carrier 324. As will also be appreciated, this advantageously results in a reduction of damage to the first type labels 328, such as from handling errors or from static electricity, and also reduces manufacturing costs as a second release liner is not required.

Although in the embodiment described above, a single second type label is applied to the label surface of each first type label, in other embodiments, two or more labels may be alternatively applied to the label surface of each first type label. In these embodiments, the two or more labels applied to the label surface of each first type label may be pressure-sensitive labels of any size, shape, material, and function.

Although embodiments have been described above with reference to the accompanying drawings, those of skill in the art will appreciate that variations and modifications may be made without departing from the spirit and scope thereof as defined by the appended claims.

1-27. (canceled)

28. A method for applying labels to a substrate comprising:
providing a release liner having a repeating sequence of pluralities of pressure-sensitive labels disposed thereon, each of the pluralities comprising at least two labels; and
applying at least one plurality of labels to a substrate using a label applicator.

29. A method according to claim 28, wherein said applying comprises applying the at least one plurality of labels to substrates delivered to said label applicator in succession.

30. A method according to claim 29, wherein said applying comprises applying only one plurality of labels to each substrate.

31. A method according to claim 29, wherein the at least two labels of each plurality are disposed on a surface of the release liner.

32. A method according to claim 31, wherein the at least two labels of each plurality are any of decorative labels, alphanumeric labels, barcode labels, and labels comprising a functional device.

33. A method according to claim 32, wherein the functional device is any of an electromagnetic device, an acousto-magnetic device, a radio frequency device, a microwave device, and a radio frequency identification device.

34. A method according to claim 31, wherein at least one of the at least two labels of each plurality is an anti-theft label.

35. A method according to claim 31, wherein the at least two labels of each plurality are applied to the substrate substantially simultaneously.

36. A method according to claim 31, wherein the at least two labels of each plurality are non-identical.

37. A method according to claim 29, wherein each plurality of labels comprises a first label and at least one second label, the first label being disposed on a surface of the release liner, and the at least one second label being disposed on a surface of the first label.

38. A method according to claim 37, wherein the first label and the at least one second label are any of decorative labels, alphanumeric labels, barcode labels, and labels comprising a functional device.

39. A method according to claim 38, wherein the functional device is any of an electromagnetic device, an acousto-magnetic device, a radio frequency device, a microwave device, and a radio frequency identification device.

40. A method according to claim 37, wherein at least one of the first label and the at least one second label is an anti-theft label.

41. A method according to claim 37, wherein the at least one second label is applied to the surface of the first label while the first label is already disposed on the release liner.

42. A label carrier comprising a release liner having a repeating sequence of pluralities of pressure-sensitive labels disposed thereon, each plurality of labels comprising at least two differing labels.

43. A label carrier according to claim 42, wherein the labels of each plurality are disposed on a surface of the release liner.

44. A label carrier according to claim 42, wherein the labels of each plurality are selected from the group consisting of decorative labels, alphanumeric labels, barcode labels, and labels comprising a functional device.

45. A label carrier according to claim 44, wherein the functional device is selected from the group consisting of electromagnetic devices, acousto-magnetic devices, radio frequency devices, microwave devices, and radio frequency identification devices.

46. A label carrier according to claim 42, wherein at least one of the labels of each plurality is an anti-theft label.

47. A label carrier according to claim 42, wherein each plurality of labels comprises a first label and at least one second label, the first label being disposed on a surface of the release liner, and the second label being disposed on a surface of the first label.

48. A label carrier according to claim 47, wherein the first label and the at least one second label are any of decorative labels, alphanumeric labels, barcode labels, and labels comprising a functional device.

49. A label carrier according to claim 48, wherein the functional device is any of an electromagnetic device, an acousto-magnetic device, a radio frequency device, a microwave device, and a radio frequency identification device.

50. A label carrier according to claim 47, wherein at least one of the at least two labels is an anti-theft label.

51. A label carrier according to claim 47, wherein the first label comprises an active region, and wherein the surface of the first label to which the second label is disposed is surface being adjacent the active region.

52. A label application system comprising:
a label applicator loaded with a label carrier according to claim 16; and
a conveying mechanism to deliver substrates in succession to said label applicator, said label applicator applying at least one plurality of labels to each substrate.

53. A label application system according to claim 52, wherein said label applicator applies only one plurality of labels to each substrate.
